(19) United States
(12) Patent Application Publication
(10) Pub. No.: US 2011/0254868 A1
(43) Pub. Date: Oct. 20, 2011

(54) Field emission lamp

(75) Inventors: Chi-Tsung Lo, Taipei (TW); Tzung-Han Yang, Taipei (TW); Yung-Chih Yu, Taipei (TW); Ching-Hsuang Cheng, Taipei (TW)

(73) Assignee: Tatung Company, Taipei (TW)

(21) Appl. No.: 12/801,414

(22) Filed: Jun. 8, 2010

(30) Foreign Application Priority Data
Apr. 14, 2010 (TW) 099111594

(51) Int. Cl. G09G 5/10

(52) U.S. Cl. 345/690

(57) ABSTRACT

A field emission lamp is disclosed, which comprises: a substrate, a plurality of first field emission units, a plurality of second field emission units, and a driving control unit. The plurality of first field emission units and the plurality of second field emission units are located on the substrate. Besides, the first phosphor layer of the plurality of first field emission units has a first color temperature. The second phosphor layer of the plurality of second field emission units has a second color temperature, wherein the first color temperature is higher than the second color temperature. Moreover, the driving control unit drives and controls the plurality of first field emission units and the plurality of second field emission units based on a predetermined driving mode, for modulating the light emission mode of the field emission lamp and the color temperature of the mixed light emitted from the field emission lamp.

### BACKGROUND OF THE INVENTION

1. Field of the Invention

The present invention relates to a field emission lamp and, more particularly, to a field emission lamp capable of modulating the light emission mode of the field emission lamp and the color temperature of the mixed light emitted therefrom.

2. Description of Related Art

Currently, as the conventional field emission lamp consists only of a plurality of field emission units of the same kind, and all of the phosphor layers of the plurality of field emission units have the same color temperature, the color temperature of the light emitted from the conventional field emission lamp is fixed to a certain value, unable to be modulated based on different application circumstances.

As a result, for an application circumstance in which the conventional field emission lamp is required to provide light of different color temperature, for example, a place to display the light variation from the day to night, different kinds of conventional field emission lamps each having different color temperature range must be installed, for providing light of different color temperature to the place, respectively. However, a large space is required for the installation of these differing conventional field emission lamps. Additionally, a controller is required, for controlling the light emission of each of these conventional field emission lamps of different kinds, along with the light intensity of the light emitted therefrom, which is inconvenient to the user in the industry.

Therefore, a field emission lamp capable of modulating the light emission mode thereof and the color temperature of the mixed light emitted therefrom is required, for minimizing the required installation space and the precluding the requirement of the additional control system.

### SUMMARY OF THE INVENTION

The object of the present invention is to provide a field emission lamp capable of modulating the light emission mode thereof and the color temperature of the mixed light emitted therefrom.

To achieve the object, the field emission lamp of the present invention comprises: a substrate; a plurality of first field emission units, each of the plurality of first field emission units including a first cathode portion, a first anode portion, and a first phosphor layer, wherein the first phosphor layer is formed on the first anode portion; a plurality of second field emission units, each of the plurality of second field emission units including a second cathode portion, a second anode portion, and a second phosphor layer, wherein the second phosphor layer is formed on the second anode portion; and a driving control unit, including a first driving portion and a second driving portion, wherein the first driving portion is electrically connected with the first cathode portion and the first anode portion of each of the plurality of first field emission units, and the second driving portion is electrically connected with the second cathode portion and the second anode portion of each of the plurality of second field emission units; wherein the plurality of first field emission units and the plurality of second field emission units are located on the substrate; the first phosphor layer of the plurality of first field emission units has a first color temperature, the second phosphor layer of the plurality of second field emission units has a second color temperature, wherein the first color temperature is higher than the second color temperature; the driving control unit drives the plurality of first field emission units and the plurality of second field emission units, and controls the light emission mode and the light intensity emitted therefrom, respectively, based on a predetermined driving mode, for modulating the light emission mode and the light intensity of the mixed light emitted from the field emission lamp.

Therefore, as the driving control unit of the field emission lamp of the present invention can drive the plurality of first field emission units and the plurality of second field emission units, and control the light emission mode of both the plurality of first field emission units and the plurality of second field emission units, along with the light intensity of the light emitted from the field emission lamp of the present invention, respectively, employing the first driving portion and the second driving portion thereof, wherein the first color temperature of the first phosphor layer of the plurality of first field emission units is higher than the second color temperature of the second phosphor layer of the plurality of second field emission units. Both of the light emission mode of the field emission lamp of the present invention and the color temperature of the mixed light emitted from the field emission lamp of the present invention can be modulated, by means of controlling the time-domain variation and the value of the first driving voltage output to the plurality of first field emission units and the time-domain variation and the value of the second driving voltage output to the plurality of second field emission units, based on the driving mode which the driving control unit applied.

Other objects, advantages, and novel features of the invention will become more apparent from the following detailed description when taken in conjunction with the accompanying drawings.

### BRIEF DESCRIPTION OF THE DRAWINGS

FIG. 1 is a top view of the field emission lamp according to a first embodiment of the present invention.

FIG. 2 is a cross-sectional view of the field emission lamp according to the first embodiment of the present invention, taking along the line AA′ of FIG. 1.

FIG. 3 is a sequence diagram displaying the driving mode of the driving control unit of the field emission lamp according to the first embodiment of the present invention.

FIG. 4 is a sequence diagram displaying the driving mode of the driving control unit of the field emission lamp according to a second embodiment of the present invention.

FIG. 5 is a sequence diagram displaying the driving mode of the driving control unit of the field emission lamp according to a third embodiment of the present invention.

### DETAILED DESCRIPTION OF THE PREFERRED EMBODIMENT

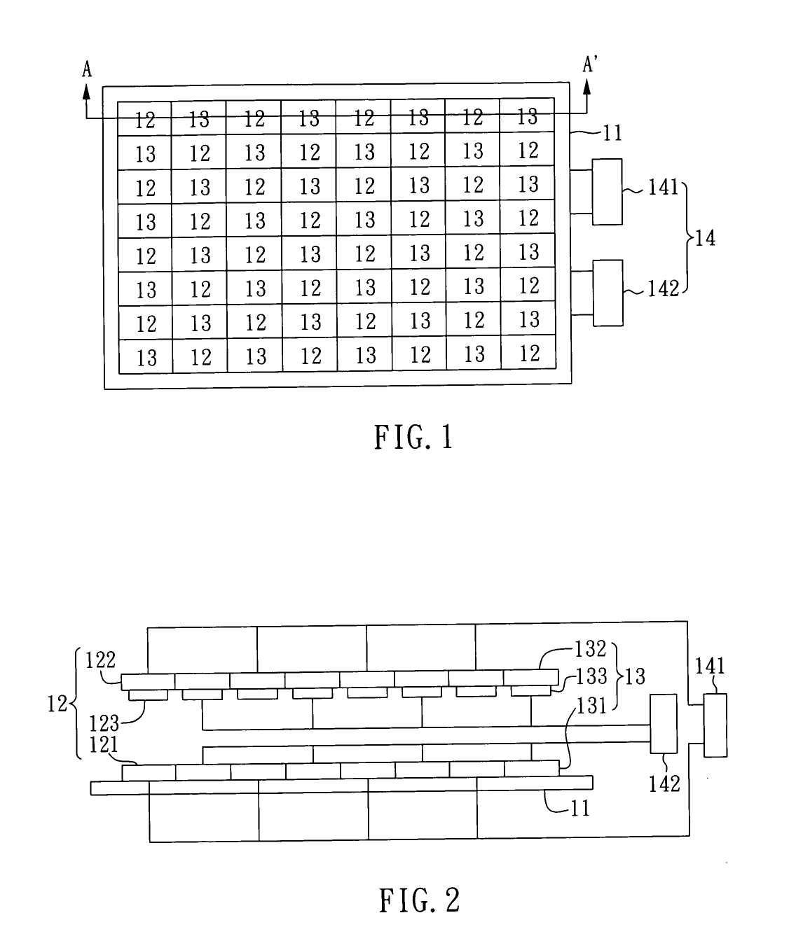

With reference to FIGS. 1 and 2, wherein FIG. 1 is a top view of the field emission lamp according to a first embodiment of the present invention, and FIG. 2 is a cross-sectional view of the field emission lamp according to the first embodiment of the present invention, taking along line AA′ of FIG. 1. The field emission lamp according to the first embodiment of the present invention comprises: a substrate 11, a plurality of first field emission units 12, a plurality of second field emission units 13, and a driving control unit 14, wherein the plurality of first field emission units 12 and the plurality of second field emission units 13 are located on the substrate 11.

Besides, each of the plurality of first field emission units 12 includes a first cathode portion 121, a first anode portion 122, and a first phosphor layer 123, wherein the first phosphor layer 123 is formed on the first anode portion 122. Moreover, each of the plurality of second field emission units 13 includes a second cathode portion 131, a second anode portion 132, and a second phosphor layer 133, wherein the second phosphor layer 133 is formed on the second anode portion 132. The first phosphor layer 123 of each of the plurality of first field emission units 12 has a first color temperature, while the second phosphor layer 133 of each of the plurality of second field emission units 13 has a second color temperature, wherein the first color temperature is higher than the second color temperature.

As shown in FIGS. 1 and 2, the driving control unit 14 of the field emission lamp according to the first embodiment of the present invention includes a first driving portion 141 and a second driving portion 142, wherein the first driving portion 141 is electrically connected with the first cathode portion 121 and the first anode portion 122 of each of the plurality of first field emission units 12, and the second driving portion 142 is electrically connected with the second cathode portion 131 and the second anode portion 132 of each of the plurality of second field emission units 13.

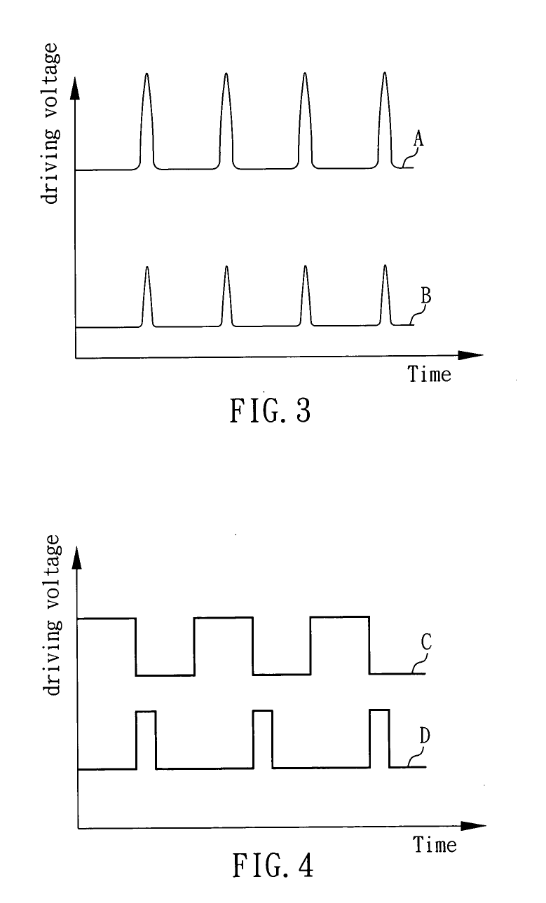

Besides, as shown in FIG. 3, which is a sequence diagram displaying the driving mode of the driving control unit of the field emission lamp according to the first embodiment of the present invention. Based on a predetermined driving mode, the driving control unit 14 of the field emission lamp according to the first embodiment of the present invention drives the plurality of first field emission units 12 and the plurality of second field emission units 13 at the same time, and controls the light emission mode and the light intensity of the emission light of both of the plurality of first field emission units 12 and the plurality of second field emission units 13, for modulating the light emission mode of the field emission lamp according to the first embodiment of the present invention and the color temperature of the mixed light emitted therefrom.

With reference to FIG. 1 again, the plurality of first field emission units 12 and the plurality of second field emission units 13 of the field emission lamp according to the first embodiment of the present invention are alternatively located on the substrate 11. That is, four out of the plurality of second field emission units 13 are arranged in the vicinity of a first field emission unit 12. In the same manner, four out of the plurality of first field emission units 12 are arranged in the vicinity of a second field emission unit 13. However, in other application circumstances, the plurality of first field emission units and the plurality of second field emission units of the field emission lamp according to the first embodiment of the present invention can be arranged on the substrate by a different distribution manner, for example, block distribution manner. That is, the plurality of first field emission units is divided into a plurality of first blocks each including a quantity of first field emission units, while the plurality of second field emission units is divided into a plurality of second blocks each including a quantity of second field emission units. Then, these first blocks and second blocks are alternatively located on the substrate.

Moreover, in the field emission lamp according to the first embodiment of the present invention, the first phosphor layer 123 of the plurality of first field emission units 12 is made of a first phosphor powder, having the first color temperature of 6500 K. Besides, the second phosphor layer 133 of the plurality of second field emission units 13 is made of a second phosphor powder, having the second color temperature of 2500 K. However, in other application circumstances, both of the first phosphor layer of the plurality of first field emission units and the second phosphor layer of the plurality of second field emission units can be made of other kinds of phosphor powder having color temperature different from the above-mentioned first and second color temperature.

As shown in FIG. 3, the driving control unit 14 of the field emission lamp according to the first embodiment of the present invention drives the plurality of first field emission units 12 and the plurality of second field emission units 13 at the same time, based on a pulse-wave driving mode. In this case, the driving frequency is higher than 60 Hz. Therefore, even though comparing with the frequency of the pulse-wave driving signal, the electron beam in the plurality of first field emission units 12 and the electron beam in the plurality of second field emission units 13 strike on the first phosphor layer 123 and the second phosphor layer 133, respectively and occasionally, the plurality of first field emission units 12 and the plurality of second field emission units 13 can still emit light continuously, due to the intrinsic property of the phosphor layers (i.e. the electroluminescence delay property). As a result, the field emission lamp according to the first embodiment of the present invention can still provide a mixed light having a certain color temperature continuously.

However, when the driving control unit 14 of the field emission lamp according to the first embodiment of the present invention drives the plurality of first field emission units 12 and the plurality of second field emission units 13 at the same time, based on a pulse-wave driving mode of a lower frequency, for example, 30 Hz or below, the plurality of first field emission units 12 and the plurality of second field emission units 13 of the field emission lamp according to the first embodiment of the present invention will emit light occasionally. Thus, the field emission lamp according to the first embodiment of the present invention will provide a mixed light having a certain color temperature occasionally.

However, it should be noticed that, in other application circumstances, the driving control unit 14 of the field emission lamp according to the first embodiment of the present invention can drive the plurality of first field emission units 12 and the plurality of second field emission units 13 at the same time, based on different kind of driving mode, for example, a sine-wave driving mode, direct current (D.C.) driving mode, or square-wave driving mode, and can control the plurality of first field emission units 12 and the plurality of second field emission units 13 to emit light in different light emission modes. Thus, the field emission lamp according to the first embodiment of the present invention can provide a mixed light having a certain color temperature in different light emission mode.

Finally, for modulating the color temperature of the mixed light emitted from the field emission lamp according to the first embodiment of the present invention, the driving control unit 14 of the field emission lamp can drive the plurality of first field emission units 12 and the plurality of second field emission units 13 with driving voltage in different values, respectively. Thus, the light intensity of the light emitted from the plurality of first field emission units 12 and that of the light emitted from the plurality of second field emission units 13 can thus be controlled, respectively. As shown in FIG. 3, the curve A represents the first driving voltage V1 output by the first driving portion of the driving control unit, and curve B represents the second driving voltage V2 output by the second driving portion of the driving control unit.

In the field emission lamp according to the first embodiment of the present invention, the first driving portion 141 drives the plurality of first field emission units 12 with the first driving voltage V1, while the second driving portion 142 drives the plurality of second field emission units 13 with the second driving voltage V2, wherein the value of the first driving voltage V1 is different from the value of the second driving voltage V2.

Moreover, in the present embodiment, for modulating the color temperature of the mixed light emitted from the field emission lamp according to the first embodiment of the present invention to the target of 6100 K, the value of the first driving voltage V1 is 5.5 KV, and the value of the second driving voltage V2 is 4.5 KV. At this time, the light intensity of the light emitted from the plurality of first field emission units 12 is 10000 nits, while the light intensity of the light emitted from the plurality of second field emission units 13 is 1000 nits. Therefore, the color temperature of the mixed light emitted from the field emission lamp according to the first embodiment of the present invention is 6136 K, very close to the target value 6100 K.

Therefore, the driving control unit 14 of the field emission lamp according to the first embodiment of the present invention can drive the plurality of first field emission units 12 and the plurality of second field emission units 13 based on different kinds of driving mode, and with different driving voltages, respectively. That is, in response to different application circumstances, the driving control unit 14 of the field emission lamp according to the first embodiment of the present invention can apply the pulse height modulation (PHM) or the pulse width modulation (PWM), to drive the plurality of first field emission units 12 and the plurality of second field emission units 13, respectively, for modulating the light emission mode of the field emission lamp according to the first embodiment of the present invention, and the color temperature of the mixed light emitted therefrom.

As shown in FIG. 4, which is a sequence diagram displaying the driving mode of the driving control unit of the field emission lamp according to a second embodiment of the present invention. In the figure, curve C represents the first driving voltage V1 output by the first driving portion of the driving control unit, and curve D represents the second driving voltage V2 output by the second driving portion of the driving control unit. Besides, since the constituted structure of the field emission lamp according to the second embodiment of the present invention is the same as that of the field emission lamp according to the first embodiment of the present invention, detailed description related to the constituted structure of the field emission lamp according to the second embodiment of the present invention is omitted hereinafter.

With reference to FIG. 4, the driving control unit 14 of the field emission lamp according to the second embodiment of the present invention drives the plurality of first field emission units and the plurality of second field emission units at different times, based on a square-wave driving mode, and controls the light emission mode (for example, light emission time) of both the plurality of first field emission units and the plurality of second field emission units, for modulating the light emission mode of the field emission lamp according to the second embodiment of the present invention, and the color temperature of the mixed light emitted therefrom.

Moreover, as shown in FIG. 4, since the distribution time of the “high state” of the first driving voltage V1 is not the same as that of the “high state” of the second driving voltage V2, the mixed light having different color temperature can be provided by modulating the length of the “high state” period of these two driving voltages. For example, when the “high state” period of the first driving voltage V1 is longer than that of the second driving voltage V2, the color temperature of the mixed light emitted from the field emission lamp is close to the first color temperature of the first phosphor layer of the first field emission unit, i.e. 6500 K. On the contrary, when the “high state” period of the second driving voltage V2 is longer than that of the first driving voltage V1, the color temperature of the mixed light emitted from the field emission lamp is close to the second color temperature of the second phosphor layer of the second field emission unit, i.e. 2500 K.

Therefore, for the example shown in FIG. 4, as the “high state” period of the first driving voltage V1 is longer than that of the second driving voltage V2, the color temperature of the mixed light emitted from the field emission lamp according to the second embodiment of the present invention is close to the first color temperature of the first phosphor layer of the first field emission unit.

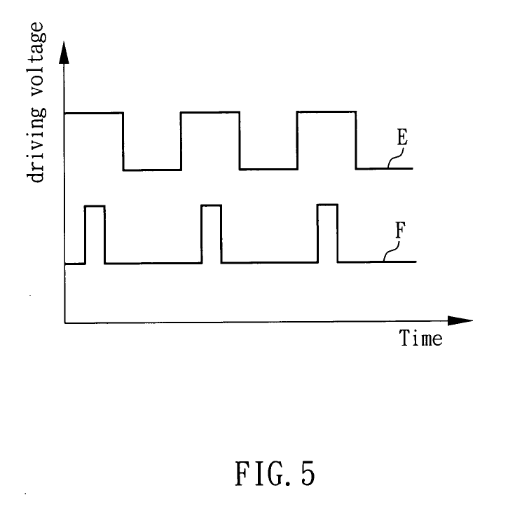

As shown in FIG. 5, which is a sequence diagram displaying the driving mode of the driving control unit of the field emission lamp according to a third embodiment of the present invention. In the figure, curve E represents the first driving voltage V1 output by the first driving portion of the driving control unit, and curve F represents the second driving voltage V2 output by the second driving portion of the driving control unit. Besides, since the constituted structure of the field emission lamp according to the third embodiment of the present invention is the same as that of the field emission lamp according to the first embodiment of the present invention, detailed description related to the constituted structure of the field emission lamp according to the third embodiment of the present invention is omitted hereinafter.

With reference to FIG. 5, the driving control unit 14 of the field emission lamp according to the third embodiment of the present invention drives the plurality of first field emission units and the plurality of second field emission units at the same time, based on a square-wave driving mode, and controls the light emission mode (for example, light emission time) of both the plurality of first field emission units and the plurality of second field emission units, for modulating the light emission mode of the field emission lamp according to the third embodiment of the present invention, and the color temperature of the mixed light emitted therefrom.

As shown in FIG. 5, as the “high state” period of the first driving voltage V1 is longer than that of the second driving voltage V2, the color temperature of the mixed light emitted from the field emission lamp according to the third embodiment of the present invention is close to the first color temperature of the first phosphor layer of the first field emission unit.

In conclusion, as the driving control unit of the field emission lamp of the present invention can drive the plurality of first field emission units and the plurality of second field emission units; and control the light emission mode of both the plurality of first field emission units and the plurality of second field emission units, along with the light intensity of the light emitted from the field emission lamp of the present invention, respectively, employing the first driving portion and the second driving portion thereof, wherein the first color temperature of the first phosphor layer of the plurality of first field emission units is higher than the second color temperature of the second phosphor layer of the plurality of second field emission units. Both of the light emission mode of the field emission lamp of the present invention and the color temperature of the mixed light emitted from the field emission lamp of the present invention can be modulated, by means of controlling the time-domain variation and the value of the first driving voltage output to the plurality of first field emission units and the time-domain variation and the value of the second driving voltage output to the plurality of second field emission units, based on the driving mode which the driving control unit applied.

Although the present invention has been explained in relation to its preferred embodiment, it is to be understood that many other possible modifications and variations can be made without departing from the scope of the invention as hereinafter claimed.

What is claimed is:

1. A field emission lamp comprising:
a substrate;
a plurality of first field emission units, each of the plurality of first field emission units including a first cathode portion, a first anode portion, and a first phosphor layer, wherein the first phosphor layer is formed on the first anode portion;
a plurality of second field emission units, each of the plurality of second field emission units including a second cathode portion, a second anode portion, and a second phosphor layer, wherein the second phosphor layer is formed on the second anode portion; and
a driving control unit, including a first driving portion and a second driving portion, wherein the first driving portion is electrically connected with the first cathode portion and the first anode portion of each of the plurality of first field emission units, and the second driving portion is electrically connected with the second cathode portion and the second anode portion of each of the plurality of second field emission units;
wherein the plurality of first field emission units and the plurality of second field emission units are located on the substrate; the first phosphor layer of the plurality of first field emission units has a first color temperature, the second phosphor layer of the plurality of second field emission units has a second color temperature, wherein the first color temperature is higher than the second color temperature; the driving control unit drives the plurality of first field emission units and the plurality of second field emission units, and controls the light emission mode and the light intensity emitted therefrom, respectively, based on a predetermined driving mode, for modulating the light emission mode and the light intensity of the mixed light emitted from the field emission lamp.

2. The field emission lamp as claimed in claim 1, wherein the plurality of first field emission units and the plurality of second field emission units are alternatively located on the substrate.

3. The field emission lamp as claimed in claim 1, wherein the first color temperature is 6500 K, and the second color temperature is 2500 K.

4. The field emission lamp as claimed in claim 1, wherein the predetermined driving mode is pulse-wave driving mode, sine-wave driving mode, direct current driving mode, or square-wave driving mode.

5. The field emission lamp as claimed in claim 1, wherein the driving control unit drives the plurality of first field emission units and the plurality of second field emission units at the same time.

6. The field emission lamp as claimed in claim 1, wherein the driving control unit drives the plurality of first field emission units and the plurality of second field emission units with a first driving voltage and a second driving voltage, respectively, while the value of the first driving voltage is different from the value of the second driving voltage.
